(19) United States
(12) Patent Application Publication
(10) Pub. No.: US 2024/0201400 A1
(43) Pub. Date: Jun. 20, 2024

(54) RADIATION DOSIMETRY USING A MOBILE COMPUTING DEVICE

(71) Applicant: GEORGIA TECH RESEARCH CORPORATION, Atlanta, GA (US)

(72) Inventors: Zhitao KANG, Marietta, GA (US); Dongyuan HE, Fort Collins, CO (US)

(21) Appl. No.: 18/554,932

(22) PCT Filed: Apr. 12, 2022
(86) PCT No.: PCT/US2022/024420

§ 371 Date: Oct. 11, 2023

Related U.S. Application Data
(60) Provisional application No. 63/173,632, filed on Apr. 12, 2021.

(51) Int. Cl. G01T 1/105; G01T 1/17

(52) U.S. Cl. CPC G01T 1/105; G01T 1/17

(57) ABSTRACT

Described herein are devices for radiation dosimetry. An example device includes a storage phosphor element configured to absorb and store ionizing radiation; a light source configured to excite the storage phosphor element; a photodetector configured to capture light emission from the storage phosphor element; and a computing device including a processor and a memory operably coupled to the processor, the memory having computer-executable instructions stored thereon that, when executed by the processor, cause the processor to correlate an intensity of the light emission captured by the photodetector to a radiation dosage.

### CROSS-REFERENCE TO RELATED APPLICATIONS

This application claims the benefit of U.S. provisional patent application No. 63/173,632, filed on Apr. 12, 2021, and titled “RADIATION DOSIMETRY USING A MOBILE COMPUTING DEVICE,” the disclosure of which is expressly incorporated herein by reference in its entirety.

### BACKGROUND

A radiation dosimeter measures the amount of ionizing radiation that it is exposed to. Many different environments require the use of radiation dosimeters to monitor the exposure of personnel and equipment to radiation. For example, workers in the healthcare, environmental, energy, and research sectors can all be exposed to varying amounts of ionizing radiation and can use dosimeters to measure their exposure.

Existing dosimeters can be described as active or passive dosimeters. Active dosimeters can continuously measure the amount of radiation exposure. A common active dosimeter is a Geiger counter. In contrast, passive dosimeters can measure an amount of radiation exposure without continuous energy supply. One common type of passive dosimeter is a film badge. Existing active and passive dosimeters can include drawbacks for some applications. As one example, passive dosimeters can require specialized readout systems to measure the level of exposure. Similarly, active dosimeters can require a continuous supply of power while operating. Therefore, what is required are systems and methods directed to these and other considerations.

### SUMMARY

Systems, devices, and methods for radiation dosimetry using a mobile computing device are described herein.

An example device for radiation dosimetry is described herein. The device can include: a storage phosphor element configured to absorb and store ionizing radiation; a light source configured to illuminate the storage phosphor element; a photodetector configured to capture a light emission from the storage phosphor element; and a computing device including a processor and a memory operably coupled to the processor, the memory having computer-executable instructions stored thereon that, when executed by the processor, cause the processor to correlate an intensity of the light emission captured by the photodetector to a radiation dosage.

In some implementations, the storage phosphor element is a storage phosphor plate. Optionally, the storage phosphor element includes a photostimulable europium doped BaFBr, CsBr material, or photoexcitable samarium doped BaFCl, BaBPO5 phosphor or glass material.

In some implementations, the photodetector includes one or more photodiodes. Alternatively or additionally, the photodetector is an image sensor.

In some implementations, the device includes a filter arranged between the storage phosphor element and the photodetector. Optionally, the filter is configured to pass photons in the visible violet to near ultraviolet (UV) spectrum. Alternatively or additionally, the filter has a passband for photons having a wavelength between about 370 nanometers (nm) and about 400 nm.

In some implementations, the light source is configured to emit red light. Optionally, the light source is a red light emitting diode (LED). Alternatively or additionally, the light source is configured to emit light having a wavelength between about 520 nanometers (nm) and about 630 nm.

In some implementations, the light source is configured to emit ultraviolet or blue light. Alternatively or additionally, the light source is configured to emit light having a wavelength between about 360 nanometers (nm) and about 420 nm.

In some implementations, the light source is configured to emit white light, the device further includes a red-colored or blue-colored filter arranged between the storage phosphor element and the light source.

In some implementations, the device includes a housing, where the storage phosphor element and the light source are arranged inside the housing. Optionally, the housing is configured to detachably couple to the device. Alternatively or additionally, the housing is configured to maintain the storage phosphor element in a fixed position and/or orientation relative to the light source. Alternatively or additionally, the housing is configured to maintain the storage phosphor in a fixed position and/or orientation relative to the photodetector. Alternatively or additionally, the storage phosphor element is configured for slidable and reversible coupling to the housing.

In some implementations, the memory has further computer-executable instructions stored thereon that, when executed by the processor, cause the processor to analyze the light emission to determine the intensity of the light emission. Alternatively or additionally, the memory has further computer-executable instructions stored thereon that, when executed by the processor, cause the processor to generate display data for the radiation dosage. Alternatively or additionally, the memory has further computer-executable instructions stored thereon that, when executed by the processor, cause the processor to store in the memory the radiation dosage.

In some implementations, the ionizing radiation includes at least one of alpha particles, beta particles, gamma rays, or x-rays.

In some implementations, the device is a portable electronic device. Optionally, the portable electronic device is a smartphone.

In some implementations, the storage phosphor element is a photostimulable storage phosphor element, and the light emission is photo-stimulated light emission. In other implementations, the storage phosphor element is a photoexcitable storage phosphor element, and the light emission is photo-excited light emission.

An example method for performing radiation dosimetry with a portable electronic device including a storage phosphor element, a light source, and a photodetector, is described herein. The method can include illuminating, using the light source, the storage phosphor element, where the storage phosphor element has been exposed to ionizing radiation; capturing, using the photodetector, a light emission from the storage phosphor element; and correlating an intensity of the light emission captured by the photodetector to a radiation dosage.

In some implementations, the method includes exposing the storage phosphor element to the ionizing radiation.

In some implementations, the ionizing radiation includes at least one of alpha particles, beta particles, gamma rays, or x-rays.

In some implementations, the method includes filtering the light emission, where the filtered light emission is captured by the photodetector.

In some implementations, the method includes calibrating the storage phosphor element. Optionally, the step of calibrating the storage phosphor element includes: exposing the storage phosphor element to a plurality of predetermined doses of ionizing radiation; illuminating, using the light source, the storage phosphor element after exposure to each respective predetermined dose; capturing, using the photodetector, a respective light emission from the storage phosphor element after exposure to each respective predetermined dose; and determining a relationship between intensity of photo-simulated light emission and radiation dosage. Alternatively or additionally, calibrating the storage phosphor element includes illuminating, using the light source, the storage phosphor element for a predetermined period of time.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A and 1B illustrate a device and method according to an implementation of the present disclosure. FIG. 1A illustrates a block diagram of a device for performing radiation dosimetry. FIG. 1B illustrates a illustrates a method of determining an amount of radiation that a storage phosphor element has been exposed to, using the components illustrated in FIG. 1A.

FIGS. 2A and 2B illustrate spectra of light. FIG. 2A illustrates the relative response of a storage phosphor to varying stimulus wavelengths; FIG. 2B illustrates an example spectra that can be emitted (e.g., photo-stimulated emission) from a storage phosphor.

FIGS. 3A and 3B illustrate perspective views of an example device for radiation dosimetry according to an implementation of the present disclosure. FIG. 3A illustrates a perspective view from one side of the device and FIG. 3B illustrates a perspective view from another side of the device.

FIGS. 4A-4D illustrate a housing that can be part of implementations of the present disclosure. FIG. 4A illustrates a perspective view, FIG. 4B illustrates a side view, FIG. 4C illustrates another perspective view, and FIG. 4D illustrates a top view.

FIG. 5 illustrates storage phosphor plate emission signatures from a storage phosphor plate being stimulated by a red LED and captured with a 3 second exposure, according to one implementation of the present disclosure. Prior to being stimulated by the red LED, the storage phosphor plate was exposed to x-ray for 3.2 seconds.

FIG. 6 illustrates the storage phosphor plate emission signatures of FIG. 5, after performing an RGB color threshold and noise removal.

FIG. 7 illustrates storage phosphor plate emission signature from a storage phosphor plate being stimulated by a red LED and captured with a 3 second exposure, according to one implementation of the present disclosure. Prior to being stimulated by the red LED, the storage phosphor plate was exposed to x-ray for 9.6 seconds.

FIG. 8 illustrates the storage phosphor plate emission signatures of FIG. 7, after performing an RGB color threshold and noise removal.

FIGS. 9A and 9B illustrate plots of storage phosphor emission for an example implementation of the present disclosure. FIG. 9A illustrates an example of a linear plot of storage phosphor emission area over time for a storage phosphor that has been exposed to an x-ray source for three different periods of time and FIG. 9B illustrates an example of a log-log plot of storage phosphor emission area over time for a storage phosphor that has been exposed to an x-ray source for three different periods of time.

FIGS. 10A and 10B illustrate plots of storage phosphor emission for an example implementation of the present disclosure when the light source illuminating the storage phosphor is dimmed. FIG. 10A illustrates a linear plot of storage phosphor emission area over time. FIG. 10B illustrates a log-log plot of storage phosphor emission area over time.

FIG. 11 illustrates an example computing device.

FIG. 12 illustrates a plot of emission area vs. exposed time for an example implementation of the present disclosure.

FIG. 13 illustrates a plot of emission area vs. exposed time for an example implementation of the present disclosure.

FIG. 14 illustrates a configuration of a camera, LED, and storage phosphor plate according to an example implementation of the present disclosure.

FIG. 15 illustrates images of the emission from a storage phosphor after RGB thresholding and noise reduction has been performed to create a black and white image.

FIG. 16 illustrates a plot of emission area vs exposed time for an example implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

An example radiation dosimetry system includes a radiation storage component, a light source configured to excite the radiation storage component, and a mobile computing device including an image capture device that is configured to capture photo-stimulated light emission from the radiation storage component. Additionally, the mobile computing device is optionally configured to correlate the intensity of the photo-stimulated light emission to radiation dosage. Optionally, in some implementations, the radiation dosimetry system includes a filter that is attachable to the image capture device, where the filter is configured to pass photo-stimulated light emission wavelengths.

According to one implementation described herein, an example radiation storage system includes a storage phosphor plate, a red LED, and a smartphone camera. Optionally, in some implementations, the radiation dosimetry system includes a filter that is attachable to the smartphone camera. The storage phosphor material (BaFBr:Eu) can be used to capture energy from gamma rays, x-rays, beta particles and alpha particles.

It should be understood that the present disclosure contemplates that any type of ionizing radiation can be measured, detected, or correlated using implementations of the present disclosure. Throughout this disclosure, the term “ionizing radiation” refers to radiation including alpha particles, beta particles, gamma rays, and/or x-rays that are capable of energizing the storage phosphor element.

The radiation energy can be trapped in the material of the radiation storage component such as a storage phosphor plate as excited electrons and then released as near-UV light emission upon photo-stimulation with a red LED. Read out of the radiation signature is accomplished by imaging the emitted light using the smartphone back camera. The near-UV light intensity and persistence time upon red light stimulation both behave as a function of the exposed radiation dosage. As the smartphone captures the emission intensity in real-time as images, these can be used to correlate back to the initial exposed radiation dosage. The energy stored in the storage phosphor will be erased during photo-stimulation so the device can be reset for continued use. The physical sensor can be made at low cost as a compact and discrete attachment for smartphones, such as an integrated sensor inside of a smartphone protection case.

Systems, devices, and methods described herein can record radiation exposure continuously without the need of a power supply during monitoring. In comparison to passive dosimeters requiring complicated readout systems, the systems, devices, and methods described herein achieve instant readout and fast reset once power is supplied from the smartphone or a battery. The sensor can be widely deployable as phone attachments to civilians or soldiers, and the recorded data can be wirelessly transmitted to location-mapped databases for national security and environmental monitoring applications.

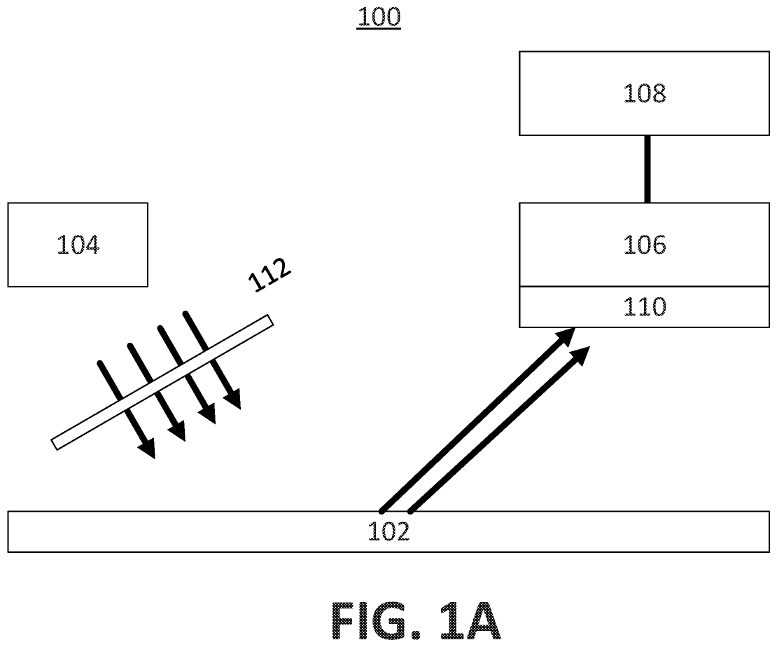

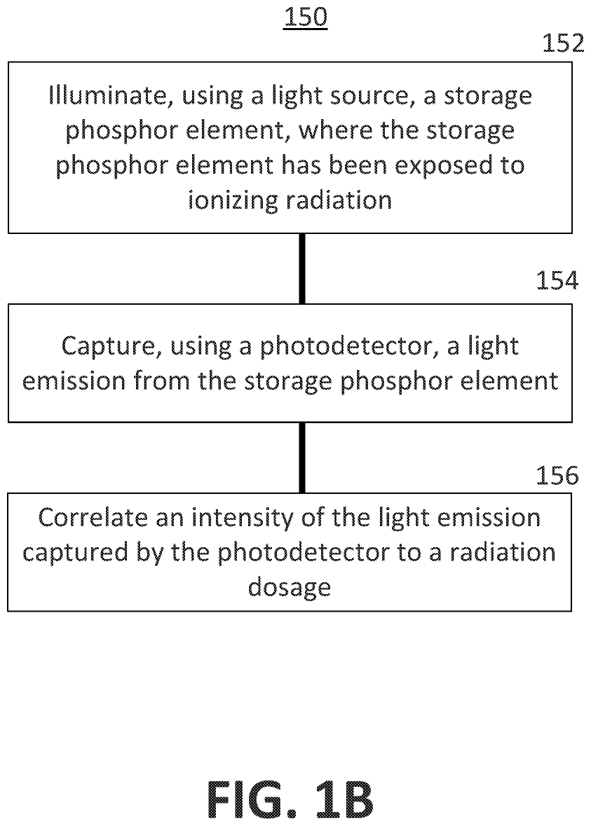

Implementations of the present disclosure are directed to devices and methods for performing radiation dosimetry. In one example implementation, the device 100 can include the components illustrated in the block diagram of FIG. 1A.

As illustrated in FIG. 1A, the device 100 can include a storage phosphor element 102 configured to absorb and store ionizing radiation. As a non-limiting example, the storage phosphor element can be a doped BaFBr material. However, it should be understood that different phosphors can be used in other implementations of the present disclosure. Throughout the present disclosure the storage phosphor element is referred to as a storage phosphor plate, but it should be understood that other shapes/sizes of storage phosphor elements are contemplated by the present disclosure. Additionally, it should be understood that the storage phosphor element 102 can be photostimulable and/or photoexcitable in different implementations of the present disclosure. Although the example implementations described herein relate to photo stimulated emissions from BaFBr material, it should be understood that the systems and methods described herein can also be applied with photoexcitable materials. In photoexcitable storage phosphors 102, the radiation-induced change can persist upon photoexcitation. For example, if stable color centers are induced, they can be repetitively read out by photoexcitation whereas in photostimulable materials one radiation induced center, e.g. electron-hole pair, that can be annihilated upon the absorption of one photon. The stored radiation signal in photoexcitable materials can be erased to reuse the sensors when irradiating them with high intensity excitation light.

The device 100 can also include a light source 104 configured to illuminate the storage phosphor element 102. In some implementations of the present disclosure, the light source 104 can be a source of red light. One non-limiting example of a red-light source is a red light emitting diode (LED). As another non-limiting example, the light source can be configured to emit light having a wavelength between about 520 nanometers (nm) and about 630 nm.

The device can also include a photodetector 106 configured to capture light emission from the storage phosphor element 102. As described above, the storage phosphor element can be photostimulable and/or photoexcitable, so the light emission from the storage phosphor element 102 can be a photo-stimulated or photoexcited emission. Again, while the examples described herein generally refer to photo-stimulated emissions from the storage phosphor plate 102, it should be again understood that the systems and methods herein can be used with photoexcited emissions from a photoexcitable storage phosphor plate 102. Different types of photodetectors 106 can be used in different implementation of the present disclosure. As one non-limiting example, the photodetector 106 can be made up of one or more photodiodes (e.g., a grid of photodiodes). In some implementations, the photodetector 106 can be an image sensor such as a charge-coupled device (CCD) or active-pixel sensor (CMOS) sensor. It should be understood that CCDs and CMOS images sensors are provided only as examples. In some implementations, the photodetector 106 can be a digital camera. Non-limiting examples of digital cameras and digital camera sensors that can be used in implementations of the present disclosure include charge-coupled device (CCD) camera sensors and active-pixel sensor (CMOS) cameras.

Optionally, in some implementations, the device 100 can include one or more filters 110 and 112. The filters can be used to filter the light emitted by the storage phosphor element 102 and/or the light emitted by the light source 104.

In some implementations, the device can include a filter 110 that is arranged between the photodetector 106 and the storage phosphor element 102. The filter 110 between the storage phosphor element 102 and the photodetector 106 can be a filter 110 configured to pass light in the visible violet to near ultraviolet spectrum, or a filter with a passband for photons having a wavelength between about 370 nanometers (nm) and about 400 nm. This filter 110 can be configured so that its passband includes some or all of the wavelengths of light that are emitted by the storage phosphor 102 when the storage phosphor is illuminated. So, in implementations where the storage phosphor element 102 is made of different types of phosphorescent materials that emit different wavelengths, the filter 110 can be configured to pass the wavelengths emitted by the phosphorescent material that is used.

Similarly, implementations of the present disclosure can use different lights sources 104. As discussed above, the light source 104 can be a red LED in some implementations. As an alternative example, some implementations can use a light source 104 configured to emit white light in combination with a filter 112 that is arranged between the light source 104 and the storage phosphor element 102 and that is configured to pass red light (e.g., a red-colored filter), i.e., to illuminate the storage phosphor element 102 with red light. Additionally, the filter 112 can be configured to pass other wavelengths of light, such as the band of wavelengths from 520 nanometers (nm) and about 630 nm, or any other wavelength of light that is required to cause the storage phosphor element 102 to emit light. Again, it should be understood that the filter wavelengths and light source wavelengths disclosed herein are intended only as non-limiting examples and that other filter wavelengths can be used to illuminate different storage phosphor materials. As another example, when the storage phosphor element 102 is a photoexcitable storage phosphor, some implementations of the present disclosure can illuminate the phosphor with light in the range from UV to blue (about 360-420 nm) for excitation. In other words, the light source 104 is configured to emit UV-blue light. As yet another example, in different implementations of the present disclosure the relationship between the excitation light and emission light can be different. As a non-limiting example, in some implementations of the present disclosure including a photoexcitable storage phosphor is used, the excitation light can be shorter than the emission light. For in some implementations of the present disclosure using a photo-stimulable storage phosphor, the stimulation light can be longer than the emission light.

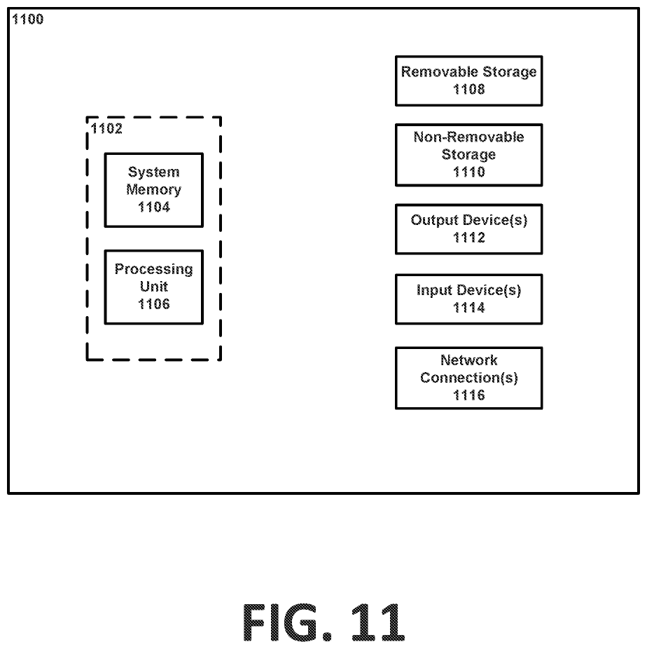

The device 100 also includes a computing device 108 that is operably coupled to the photodetector 106, for example, using a communication link. A communication link can be implemented by any medium that facilitates data exchange including, but not limited to, wired, wireless and optical links Accordingly, the computing device 108 can be configured to receive a signal, which contains information about the light emission, from the photodetector 106 and correlate an intensity of the light emission captured by the photodetector 106 to a dosage of ionizing radiation that the storage phosphor element 102 was exposed to. In some implementations of the present disclosure, the maximum intensity of light emission captured by the photodetector 106 can correlate to a radiation dosage that the storage phosphor element 102 was exposed to before being illuminated by the light source 104. As an example, the computing device 108 can contain any or all of the components of the computing device illustrated in FIG. 11.

According to some implementations implementation, the device 100 can be used to perform the method 150 illustrated in FIG. 1B. This method 150 can include illuminating 152 a storage phosphor with a light source. For example, the storage phosphor can be the storage phosphor element 102 illustrated in the block diagram of FIG. 1A, and the light source can be the light source 104 illustrated in the block diagram of FIG. 1A. As described with reference to FIG. 1A, the light source can be a red LED or can be a white light with the device including one or more filters (e.g. to allow red light), or alternatively a UV or blue LED or white light with device including one or more filters to allow light in UV-blue range.

At step 154, light emission (e.g., photo-stimulated or photo-excited) light emission can be captured from the storage phosphor using a photodetector such as the photodetector 106 described with reference to FIG. 1A. As discussed with reference to FIG. 1A, the light received by the photodetector 106 can be filtered (e.g., with a UV or violet filter).

At step 156, a correlation can be performed. This step can be performed by a computing device such as the computing device 108 described with reference to FIG. 1A. The correlation 156 can relate the intensity of the light emitted from the storage phosphor in response to illumination at step 152 and a known intensity of light that corresponds to a known amount of radiation exposure. In some implementations of the present disclosure, the correlation can be based in part on the amount of time that the phosphor is illuminated by a light source and/or the amount of time that the storage phosphor was exposed to a source of radiation.

The present disclosure contemplates that performing the correlation 156 can include using image processing techniques to measure the amount/intensity of light captured. As a non-limiting example, the image processing can include classifying the output of each of the photodetectors as illuminated or not illuminated based on whether the output of the photodetector reaches a certain threshold value. The image processing can also include determining the color of the light captured at step 154 by the photodetector and determine whether the photodetector is illuminated based on the color of the light reaching the photodetector. Additionally, noise reduction techniques can be applied to the light captured at step 154 by the photodetector. As a non-limiting example, when the photodetector is a digital camera, the noise reduction techniques can include reducing noise by comparing the intensity of light measured by one pixel to the intensity of light on the surrounding pixels and compensating for noise.

It should be understood that the relationship between radiation exposure and the intensity of photo-stimulated or photo-excited light measured by the photodetector can be based on the characteristics of each component of the device. As non-limiting examples, the intensity can depend on one or more of the following: the characteristics of the storage phosphor element; the sensitivity of the photodetector; the relative position and orientation of the photodetector, light source and storage phosphor element; and the intensity and emission spectrum of the light source itself. It should be understood that the correlation at step 156 can therefore be dependent on a calibration step or steps that are performed prior to the method 150 being performed, where the calibration step(s) can establish a known level of intensity for a known amount of radiation exposure and the correlation at step 156 can therefore determine an amount of radiation exposure based on the level of intensity captured at step 154. In some implementations of the present disclosure, the calibration step can include exposing the storage phosphor element to one or more predetermined doses of ionizing radiation, illuminating the storage phosphor after each of the one or more doses of ionizing radiation, and capturing the respective photo-stimulated or photo-excited light emissions from the storage phosphor element after each exposure to each respective dose of ionizing radiation. Based on the intensity of the respective photo-stimulated or photo-excited light emissions from the storage phosphor element, the relationship between the intensity of photo stimulated light emission and radiation dosage can be determined.

Additionally, the method 150 can optionally include generating display data for the radiation dosage based on at least the correlation at step 156. The display data can, for example, include an estimate of the amount of radiation exposure in various units (roentgen, rem, gray, rad, sievert, etc.). Additionally, the display data can be stored in memory, e.g., the memory 1104 illustrated in FIG. 11. Displaying the data can be performed using a device that is part of the computing device (e.g., the output device 1112 of FIG. 11) or the data can be transmitted over a network by a network device (e.g., the network connection 1116 shown in FIG. 11).

The present disclosure contemplates that any or all of the steps of the method 150 can be performed automatically by software, or by a user in response to software instructions. For example, in some implementations of the present disclosure, the software can display instructions to the user at step 152 that instruct the user how long to illuminate the storage phosphor or where to position the light source relative to the storage phosphor. Additionally, in some implementations of the present disclosure, at step 154 the software can instruct the user how to position the photodetector relative to the storage phosphor. The instructions that can be provided at steps 152 and 154 can also include instructing the user on how to orient the light source, photodetector, and storage phosphor relative to each other. Furthermore, image processing and data visualization can be performed through an application to provide the user with radiation exposure information immediately.

In some implementations of the present disclosure, at least some of the components illustrated in FIG. 1A and described with reference to the method of FIG. 1B can be included in a portable electronic device such as a smartphone. For example, the photodetector 106 shown in FIG. 1A can be a smartphone camera, and the computing device shown in FIG. 11 can include a processor and memory of the smartphone.

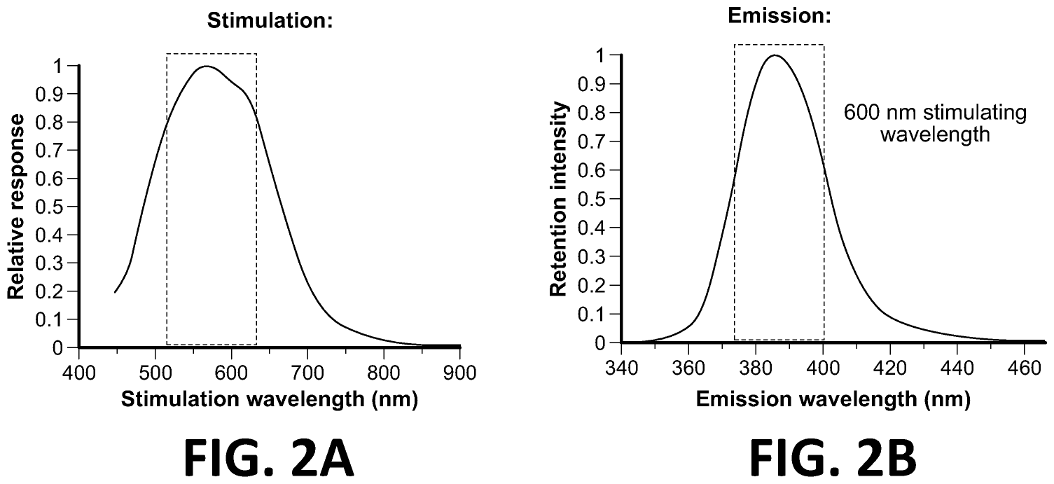

In some implementations, the method can be performed using a storage phosphor plate, a red LED, and a smartphone camera. The storage phosphor material can be used to capture energy from gamma rays, x-rays, beta particles and alpha particles. The radiation energy can be retained in the form of trapped electrons in between the conduction band and valence band. When a source of low energy red light stimulates the storage phosphor surface, the electrons can gain enough energy to jump out of the electron trap. They can then release a high energy photon before returning to the ground state. This high energy photon lies in the visible violet to near-UV spectrum. Because the emission is mostly in the visible light spectrum, the photo-stimulated light can be captured using a smartphone camera with a filter (e.g. the filter 110 illustrated in FIG. 1A) that can block out the rest of the visible light spectrum. In some implementations, the stimulus light can lie in the wavelength range between 520 nm and 630 nm for maximum photo-stimulated emission, as illustrated in FIG. 2A). And, in some implementations, the pass filter can allow light in the wavelength range between 370 nm and 400 nm for maximum photo-stimulated light emission capture as illustrated in FIG. 2B. Again, it should be understood that these wavelengths illustrated in FIGS. 2A-2B are only intended as non-limiting examples, and that other wavelengths of light can be used in implementations of the present disclosure.

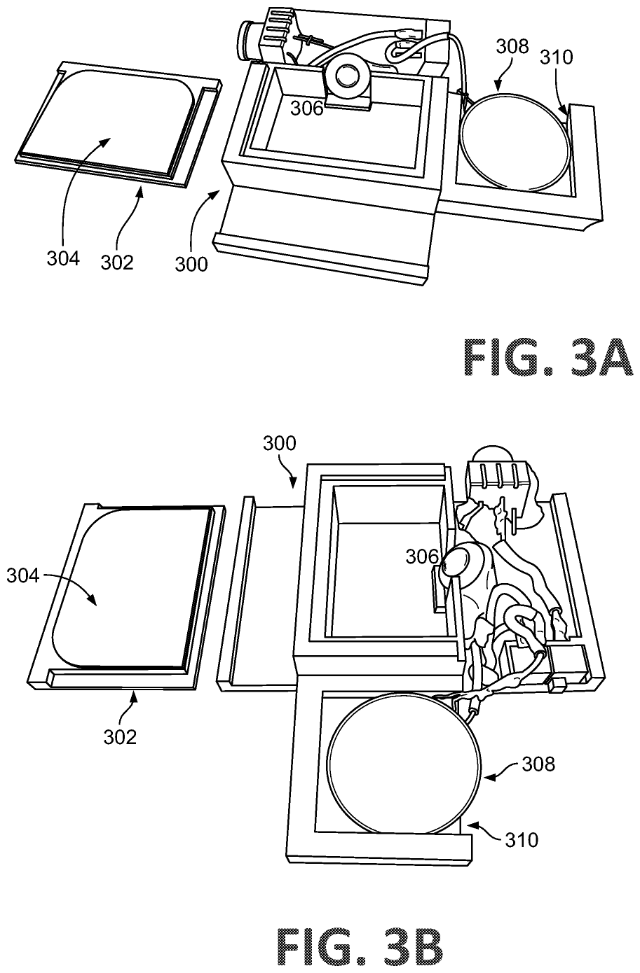

In some implementations of the present disclosure, the device can include a housing. An example housing 300 is illustrated in FIGS. 3A-3B. The housing 300 can be attached to the smartphone or integrated into a smartphone case (not shown) so that the storage phosphor element 304 is positioned in view of a smartphone camera (not shown). The present disclosure contemplates that a housing 300 can be used to attach one or more of the components to one another. For example, any or all of the elements shown in FIG. 1A can be positioned on, attached to, or positioned inside of the housing 300. Again, as a non-limiting example, the housing 300 can include a light source 306, as shown in FIGS. 3A-3B.

Additionally, as illustrated in FIG. 3A, the housing 300 can include a removable insert 302 for holding a storage phosphor element 304. The housing can be configured so that the insert 302 is reversible, so that the insert 302 can have a first position (e.g., facing outward) and a second position (e.g., facing inward). As an example, when the storage phosphor element 304 faces the outside, it can be placed on or near a potential radiation source to measure/detect radiation from that source. When the storage phosphor element 304 is reversed so that it faces the inside of the housing 300, it can allow be positioned so that it is in view of the photodetector (not shown) and so that the light source 306 can illuminate it.

The housing 300 can be constructed to temporarily or permanently fix two or more of the components of the device in a known position and/or orientation with respect to each other. For example, the housing 300 can fix the photodetector (not shown) in a known position and orientation with respect to the storage phosphor element 304, and can fix the light source 306 in a known position and orientation with respect to the photodetector and storage phosphor element 304. It should be understood that any of the components of the device can be attachable/detachable from the housing 300. Additionally, the correlation between the light emitted from the storage phosphor element 304 and the amount of radiation exposure can be based on a known position and orientation of the light source 306, storage phosphor 304 and housing 300.

The example housing 300 of the present disclosure illustrated in FIGS. 3A-3B was configured to meet several design constraints. The housing 300 can be 3D printed so that it can rest flat against the back of a smartphone with the storage phosphor element 304 in view of the back camera of the smartphone (not shown). As one example, the housing 300 can be held in place on the smartphone, for example, with rubber bands or other fastener. When the housing 300 is attached to the smartphone, it can be positioned so that very little visible light will reach the smartphone back camera. The red LED 306 can be controlled by an external sliding switch and the brightness can be controlled by a potentiometer (e.g. a 10 kΩ potentiometer). A battery 308 (illustrated in FIG. 3A-3B as a CR 2032 button cell battery) can power the device and slides into a slot 310 on the side of device. As illustrated in FIGS. 3A-3B, the red LED 306 can be attached at an angle (approximately 45 degrees) such that it illuminates the entire phosphor plate when switched on. In the example implementation illustrated in FIG. 3A and FIG. 3B, there can be a 10 mm gap between the smartphone back camera and the storage phosphor plate. The small gap allows a smaller piece of storage phosphor to be used without losing resolution. The total dimensions can be 70 mm wide, 55 mm long, and 11 mm tall. It should be understood that the dimensions of the gap between the smartphone back camera and the storage phosphor element, as well as the other dimensions given herein, are intended only as non-limiting examples and that other dimensions and proportions are contemplated by the present disclosure.

This disclosure contemplates that the housing 300 and any or all of the components of the device illustrated in FIG. 1A can optionally be integrated into the phone case to improve space efficiency. Additionally, the power sources described with reference to FIGS. 3A-3B are intended only as non-limiting examples. For example, a smartphone's headphone jack or charging port can also be used to provide power to the red LED. Similarly, in implementations of the present disclosure where a smartphone is not used, it should be understood that one or more power source(s) can be configured to power multiple components of the device. As an example, a battery or power supply can be configured to power an LED, computing device, and photodetector.

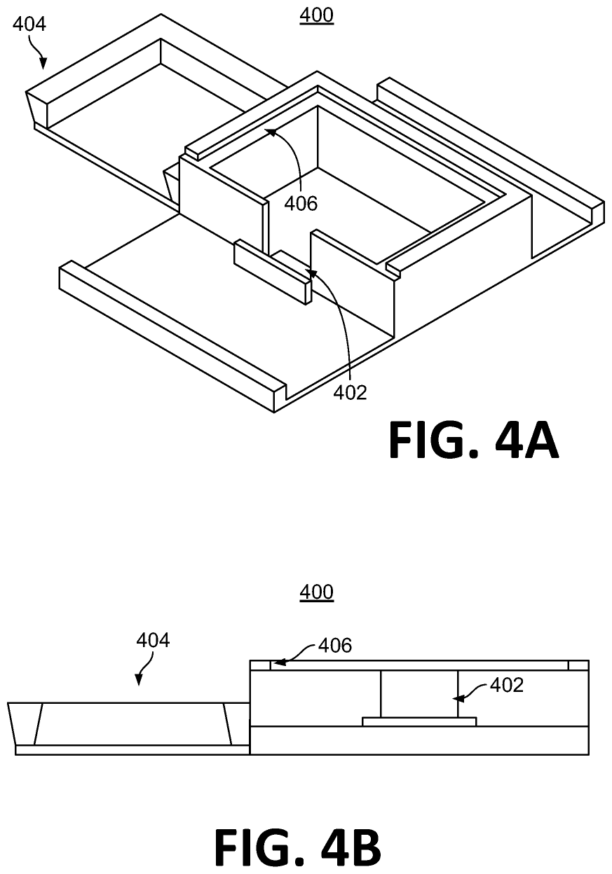

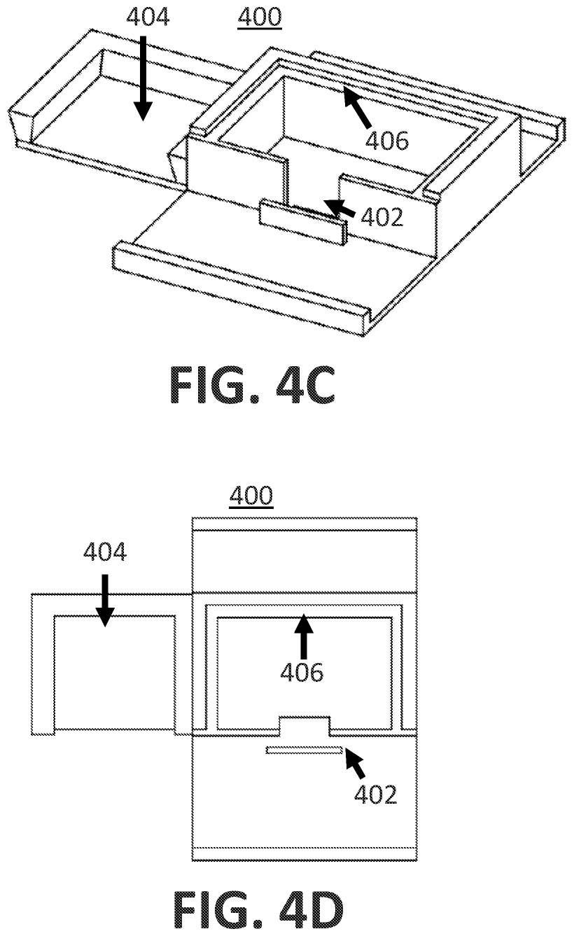

FIGS. 4A-4D illustrate views of a housing 400 according to some implementations of the present disclosure. The housing can include a slot 402 for a light source to be attached, and a battery slot 404 for a battery or other power source. The storage phosphor element (not shown) can be configured to slide in and out of a groove 406 formed in the housing 400.

It should be appreciated that the logical operations described herein with respect to the various figures may be implemented (1) as a sequence of computer implemented acts or program modules (i.e., software) running on a computing device (e.g., the computing device described in FIG. 11), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 11, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

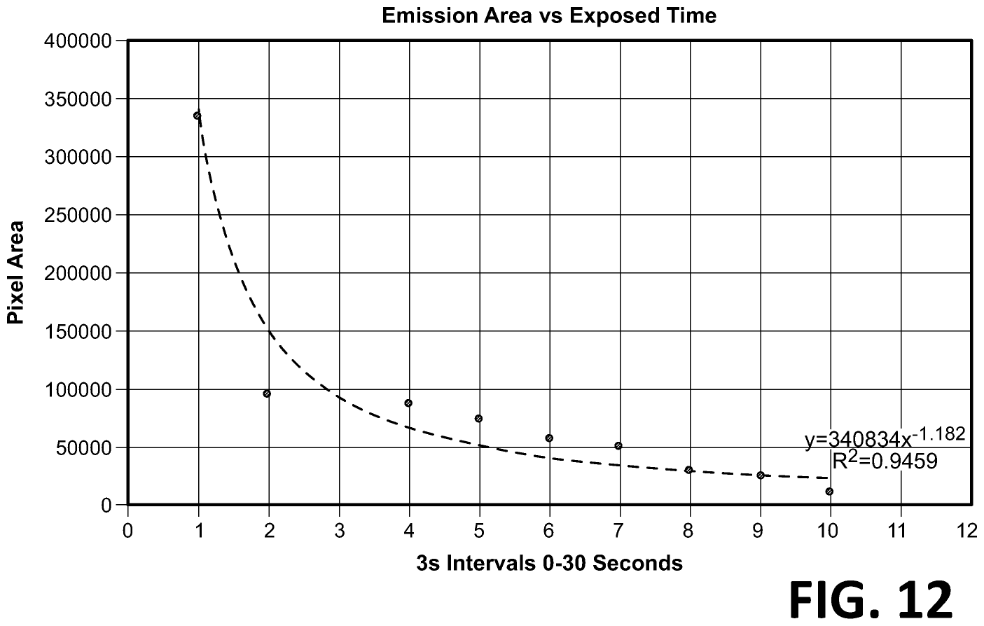

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 12 by dashed line 1102. The processing unit 1106 may be a standard programmable processor that performs arithmetic and logic operations necessary for operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110 including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112 such as a display, speakers, printer, etc. may also be included. The additional devices may be connected to the bus in order to facilitate communication of data among the components of the computing device 1100. All these devices are well known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example tangible, computer-readable media may include, but is not limited to, volatile media, non-volatile media, removable media and non-removable media implemented in any method or technology for storage of information such as computer readable instructions, data structures, program modules or other data. System memory 1104, removable storage 1108, and non-removable storage 1110 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the reference list. For example, Ref. [1] refers to the 1^{st} reference in the list. All references cited and discussed in this specification are incorporated herein by reference in their entireties and to the same extent as if each reference was individually incorporated by reference.

Moreover, the various components may be in communication via wireless and/or hardwire or other desirable and available communication means, systems and hardware. Moreover, various components and modules may be substituted with other modules or components that provide similar functions.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5).

Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] Leblans, P., Vandenbroucke, D., & Willems, P. (2011). Storage Phosphors for MedicalImaging. Materials, 4(6), 1034-1086. doi: 10.3390/ma4061034
[2] Amersham Biosciences, “Storage Phosphor Screens”, 63-0028-99, November 2003.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

Tests of an example implementation of the present disclosure were performed. A dental x-ray system sold under the trademark Siemens Portaray Heliodent® 70 Model D3152 was used to expose the storage phosphor plate. The phosphor plate was placed directly underneath the imaging cone of the system. Every exposure was performed in increments of 3.2 seconds. Exposure times of 3.2, 6.4, and 9.6 seconds were tested.

Smartphone camera setup: the back camera of a smartphone sold under the trademark OnePlus 6 running the Android operating system was used to take the images in this example. A medium blue PET filter sold under the trademark Rosco #83 was held in place against the smartphone back camera with a phone case. The default Android Camera Pro Mode was used for all photos taken. The ISO (gain) was set to 3200. The shutter speed (exposure time) was set to 3 seconds. The focal length was 4 mm.

Excitation stimulus setup: the excitation source was a 1 W red LED (620-625 nm). This is in a series connection with a sliding switch and a 10 k22 potentiometer. The entire circuit is powered by a 3V CR 2032 button cell lithium battery.

Experimental setup: in a dark room, the storage phosphor plate was exposed to the x-ray source. The phosphor plate was then transferred onto the imaging prototype device and held in place by a rubber band. The smartphone camera settings were prepared beforehand. Immediately after the red LED was switched on, images were consecutively taken for approximately one minute.

Results: after the raw images were obtained, a color thresholding technique was performed. The color thresholding changes any pixel in the image with a red value of 0-60, a green value of 0-10, and a blue value of 20-255 into white. Any pixel in the image with a red value of 61-255, a green value of 11-255, and a blue value of 0-19 changes to black. This creates an image with only black (0 intensity) and white (255 intensity). After color thresholding, a noise removal algorithm was performed. Given any pixel in the image, the algorithm takes the median value of the surrounding area of 5 pixel radius and compares the given pixel intensity with the median area intensity. If the pixel intensity is a value of 50 or less than the median area intensity value, the pixel is changed to white. This is performed on every pixel in the image parallelly. The same color thresholding and noise removal algorithm was performed on all images taken.

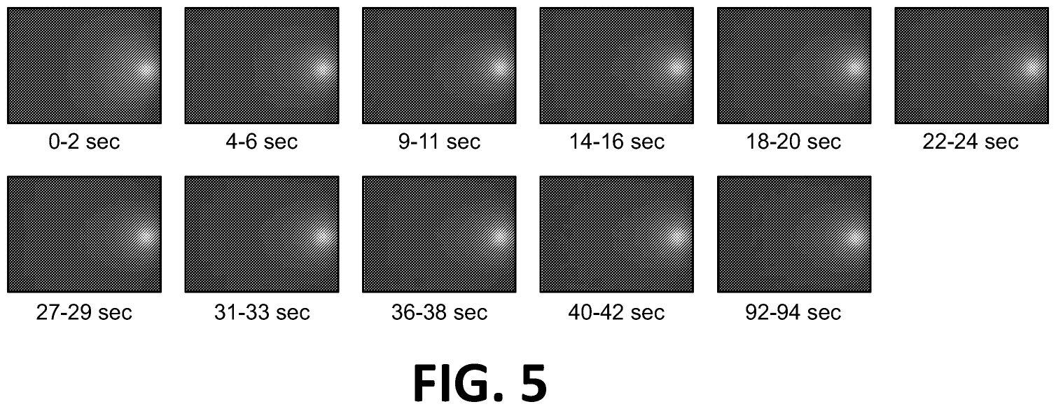

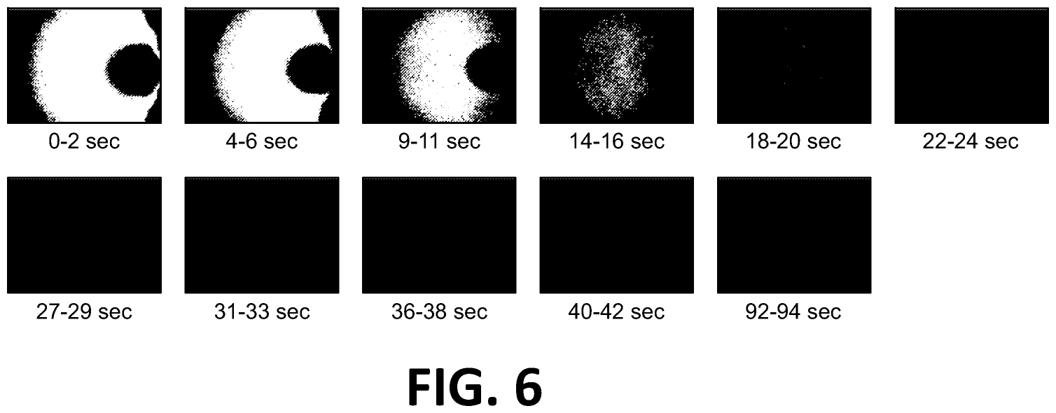

The experiment was performed six times. The resistance of the potentiometer was set at a very low value for the first three experiments. This allowed for a brighter excitation source (red LED). The next three experiments were performed with a dimmer red LED. The x-ray exposure time was varied to provide 3.2 seconds, 6.4 seconds, and 9.6 seconds of x-ray exposure to the storage phosphor plate. FIG. 5 shows the raw images taken with a bright excitation source when the phosphor plate was exposed to the x-ray for 3.2 seconds. The processed images with thresholding and noise removal are shown in FIG. 6. The emission signature disappeared at approximately 20 seconds.

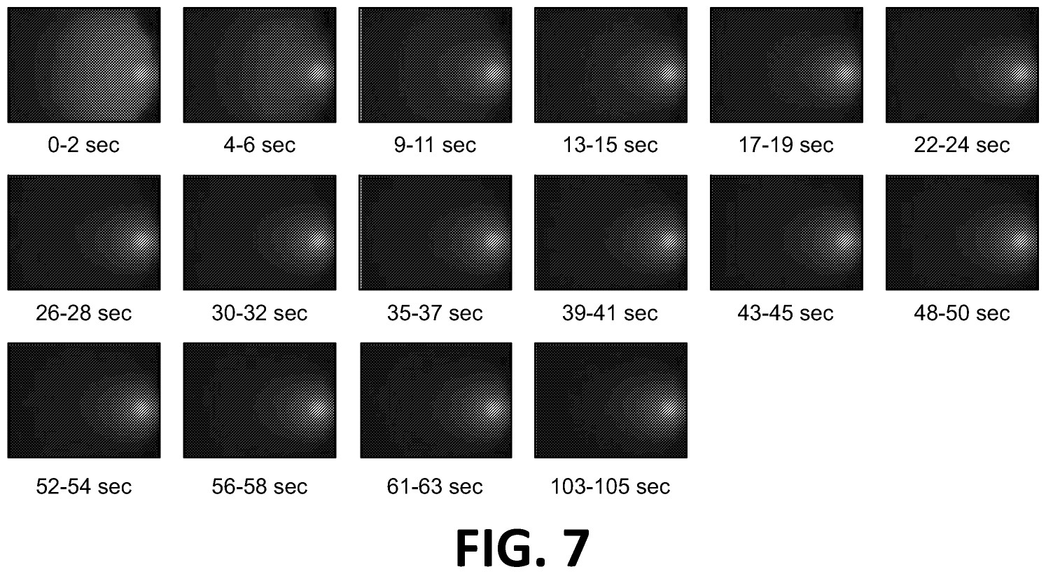

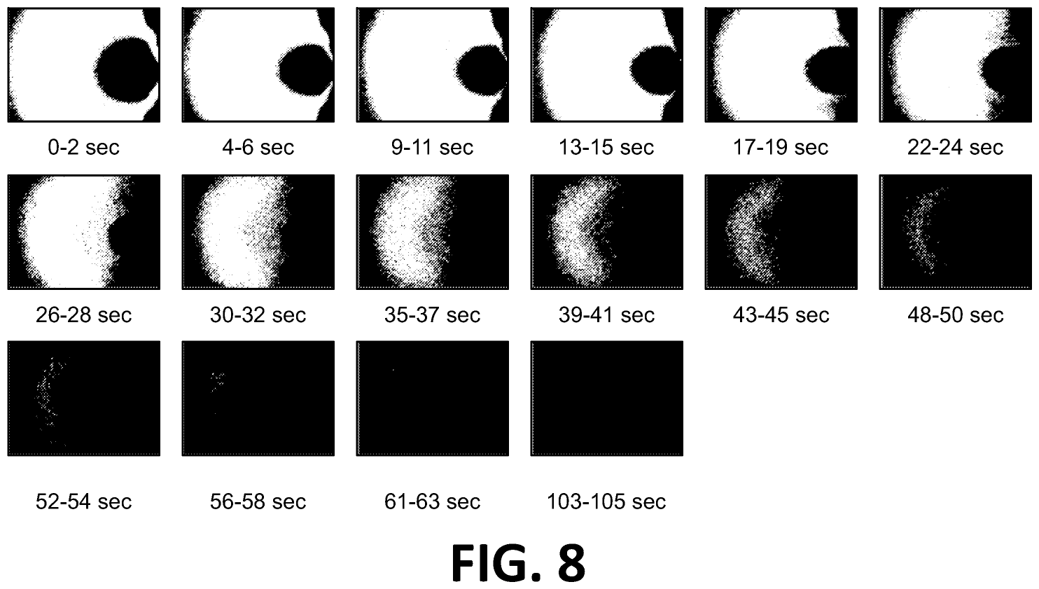

As the x-ray exposure time increases, the storage phosphor emission signature becomes much brighter. The longer exposure time allows the storage phosphor to capture more x-ray energy. This allows the storage phosphor to release more energy when stimulated, generating a brighter and longer emission signature. FIG. 7 illustrates the raw images taken with a bright excitation source when the phosphor plate was exposed to the x-ray for 9.6 seconds. The processed images with thresholding and noise removal are shown in FIG. 8. The emission signature disappeared at approximately 60 seconds.

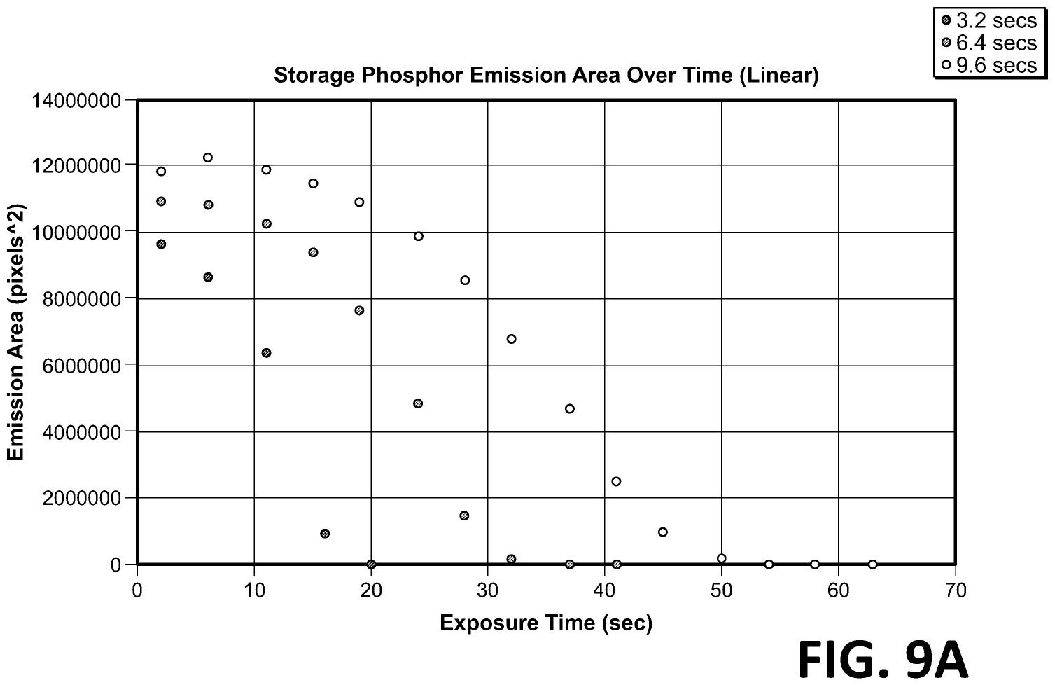

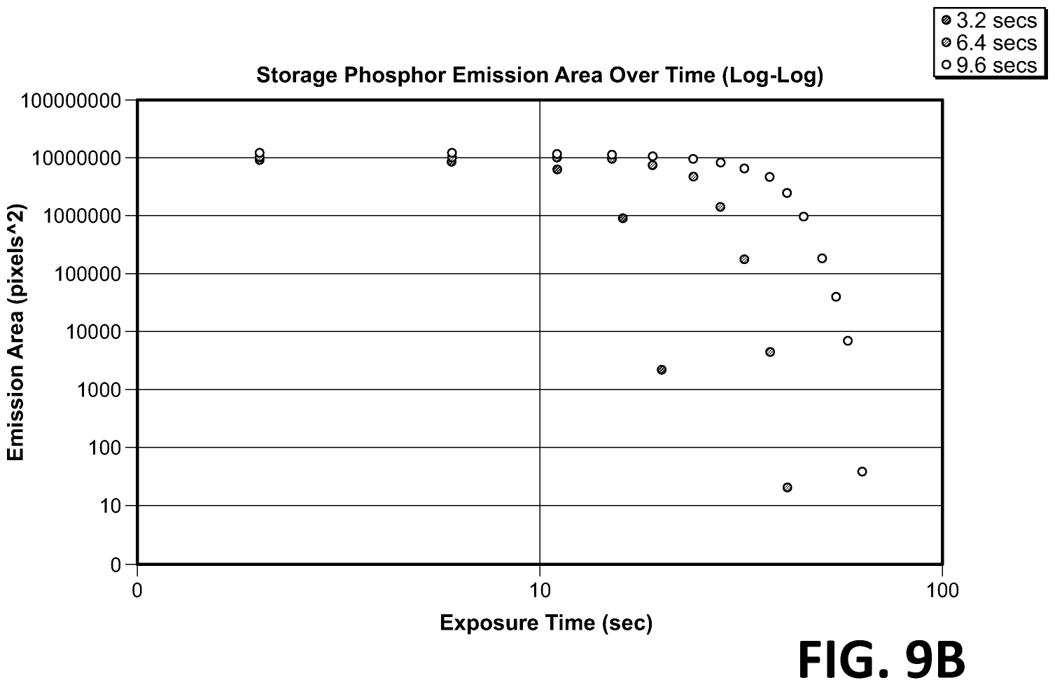

The effect of x-ray exposure time vs the storage phosphor UV emission signature can be seen more clearly in FIG. 9A The emission area of each image is calculated as the number of pixels that pass through the color thresholding and noise removal algorithm. The same data is plotted on a log-log scale FIG. 9B.

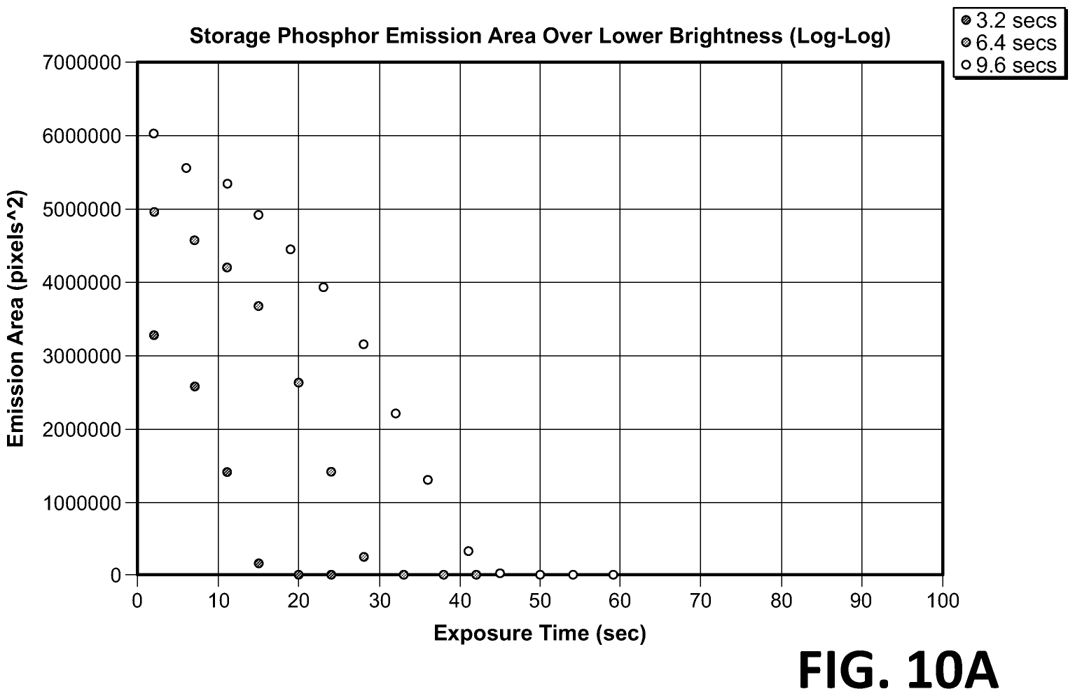

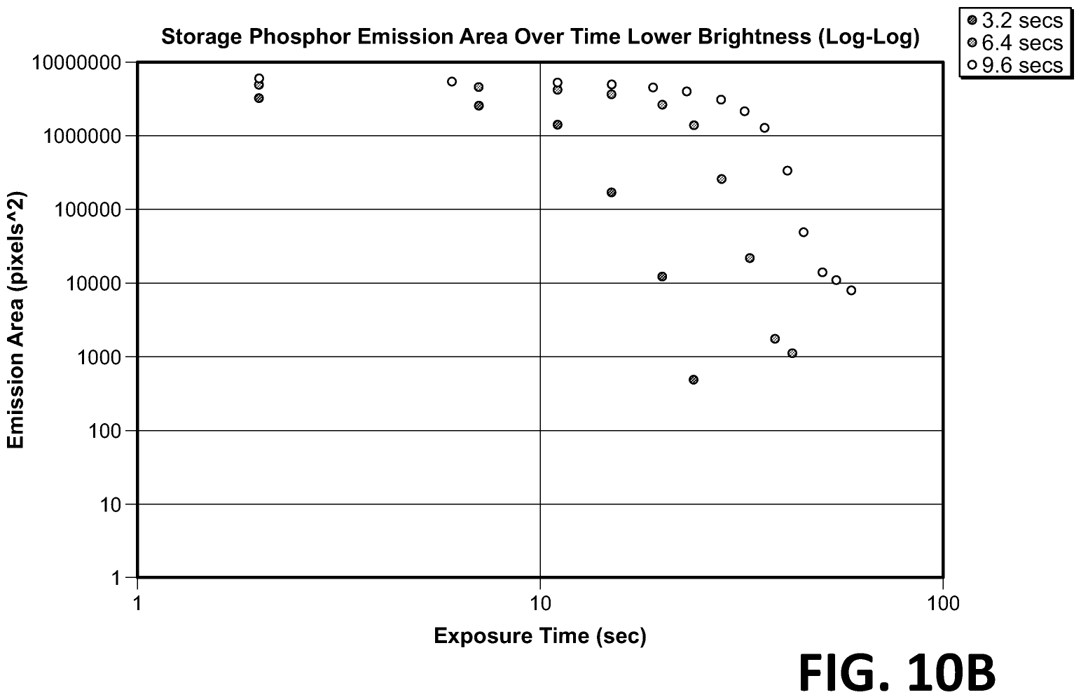

The emission area from the storage phosphor significantly decreases when the red LED stimulus is dimmed (FIG. 10A). Even with the same x-ray exposure duration, a dimmer stimulus source would generate fewer high energy photons to be captured as the emission signature. The same data has been plotted on a log-log scale (FIG. 10B).

### Example 2

An example implementation of the present disclosure was tested. Both an Americium-241 source and a storage phosphor plate were placed in a box for several hours. The storage phosphor plate was positioned on top of the Americium-241 source while inside the box. A UV filter was attached to the camera of a smartphone, and the smartphone was placed on a tripod. The box including the source and the storage phosphor plate were placed inside a closet. Then, the storage phosphor plate was removed and positioned to face the smartphone camera. A 9V battery was attached to a red LED, and the plate was immediately photographed. The LED operated at approximately 0.123 W, and was connected in series with a 660 ohm resistor.

### Example 3

Another example implementation of the present disclosure was tested. Both an Americium-241 source and a storage phosphor plate were placed in a box for several hours. The storage phosphor plate was positioned on top of the Americium-241 source while inside the box. A UV filter was attached to the camera of a smartphone, and the smartphone was placed on a tripod. The storage phosphor plate was removed and placed inside a tissue box with a RED LED. The phone was positioned to face the smartphone camera. A 9V battery was attached to the red LED, and the plate was immediately photographed. The LED operated at approximately 0.123 W, and was connected to the 9V battery in series with a 660 ohm resistor. A series of photos were taken of the resulting emission signature and the pixel area of the emission signature was plotted, as illustrated in FIG. 12.

### Example 4

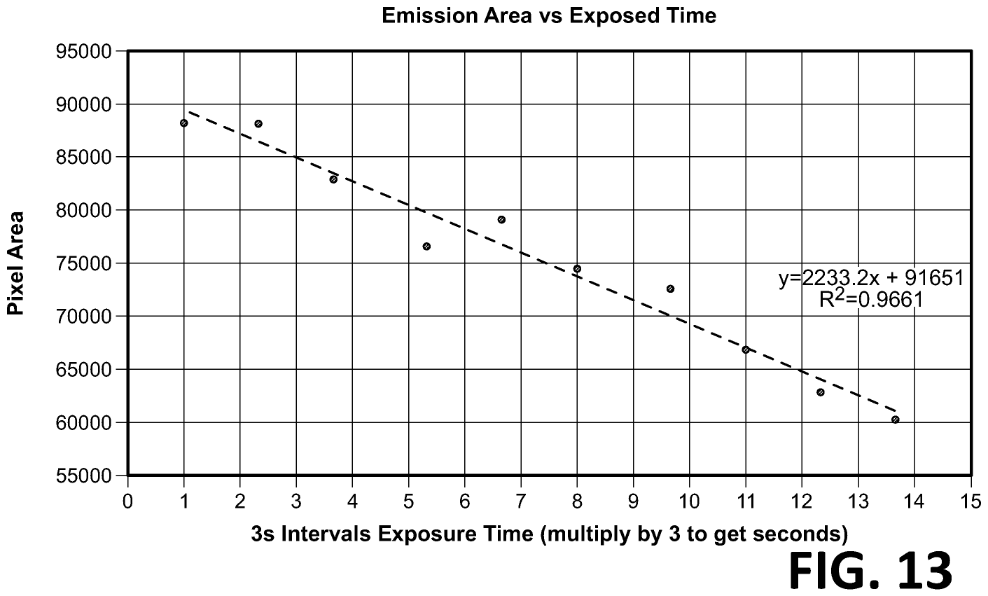

Another example implementation of the present disclosure was tested according to the procedure of example 3, above. However, the red LED was replaced with a white LED powered by 2 AAA batteries. The white Led was covered with a pair of filters configured to allow purple and red light to pass, but block other types of wavelengths. The purple filter was a iris purple PET filter sold under the trademark Rosco #377, and the red filter was a red filter sold under the trademark Thorlabs Like in the previous examples, a UV filter sold under the trademark Thorlabs was placed on the smartphone camera. Another series of photos were taken of the resulting emission signatures, and the pixel area was again plotted against the exposure time, as illustrated in FIG. 13.

### Example 5

Another example implementation of the present disclosure was tested according to the procedure of example 3, above. In this example, a white LED was used powered by 2 AAA batteries. A Deep Amber PET filter sold under the trademark Rosco #22 and a Leaf Green PET filter sold under the trademark Rosco #386 were placed over white LED. Additionally, a UV filter sold under the trademark Thorlabs was placed on the smartphone camera. Again, the example implementation successfully stimulated detectable emissions from the storage phosphor.

### Example 6

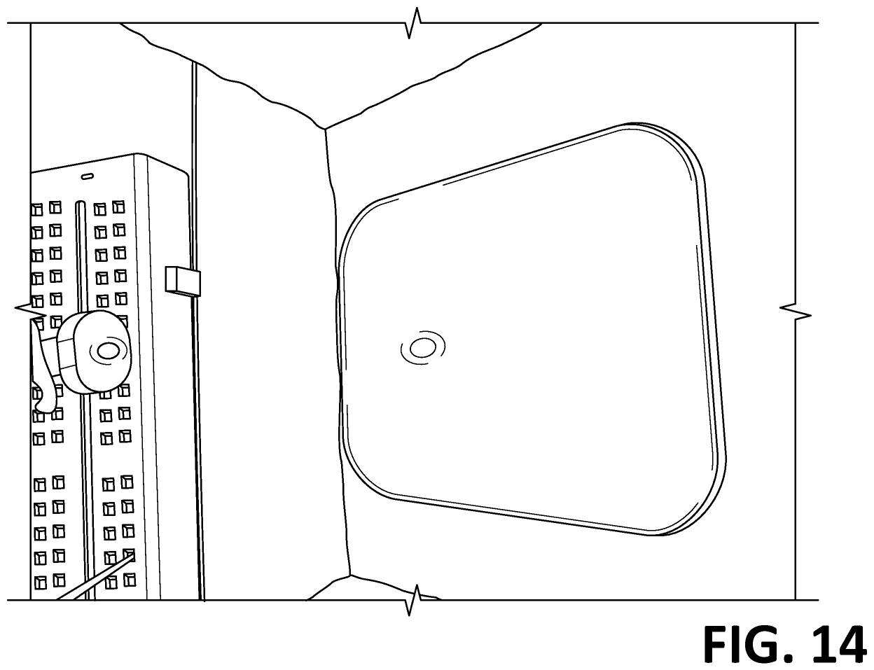

Yet another additional example implantation of the present disclosure was tested. In this non-limiting example, the Americium source was positioned so that the storage phosphor plate received gamma rays but not alpha particles from the Americium source. The source was positioned so that the storage phosphor was exposed for 12 hours. After the 12-hour exposure, a 1 W red LED was used to perform stimulation. A medium blue PET filter sold under the trademark Rosco #83 was placed on the smartphone camera. The smartphone was propped up using a cardboard stand. The storage phosphor was placed at an angle to the phone camera and LED so that there was a line of sight between both and the surface of the storage phosphor. In this example, the red LED was closer to the storage plate, which can create a faster rate of emission from the storage plate. An illustration of the LED and storage phosphor when the storage phosphor is placed 5 cm from the camera is shown in FIG. 14. However, the red LED can reflect off the storage phosphor plate which can increase the difficulty of thresholding out the emission signature.

### Example 7

Yet another additional example implementation of the present disclosure was tested. In this example implementation, the storage phosphor was a intraoral phosphor plate sold under the trademark Air Techniques ScanX. Again, the storage phosphor plate was placed on top of an Americium-241 source. In this plate, the blue side is the front side, and it was placed to face the source. The source and the storage phosphor were placed inside a cardboard box that was sealed so no outside light could enter. A double bandpass UV filter with the wavelengths 315-445 nm and 715-1095 nm sold under the trademark Thorlabs was placed on the smartphone camera lens. Again, the camera used was a smartphone sold under the trademark OnePlus 6. The shutter speed was set to three seconds (i.e., the exposure time). The ISO (i.e., gain) was set to 3200. A 1 W red LED was used with an emission wavelength from 620-625 nm.

Again, the cardboard box with the plate and source was moved into a closet without exposing the plate to visible light. The plate was then flipped over so that the front side faced the opening of the cardboard box. Then, the red LED circuit was placed inside the box with a clip attaching the LED to a battery outside the box. The opening in the cardboard box was then covered again with a piece of cardboard, and the smartphone. The smartphone was positioned so that the camera pointed at the storage phosphor plate. Then, the red LED was turned on, and ten photos were taken in sequence at three second intervals (0-2 secs, 5-7 secs, 10-12 secs, 14-16 secs, 18-20 secs, 23-25 secs, 27-29 secs, 31-33 secs, 36-38 secs, 40-42 secs). A final photo was taken in the interval from 259-261 seconds. Then, the red LED was turned off.

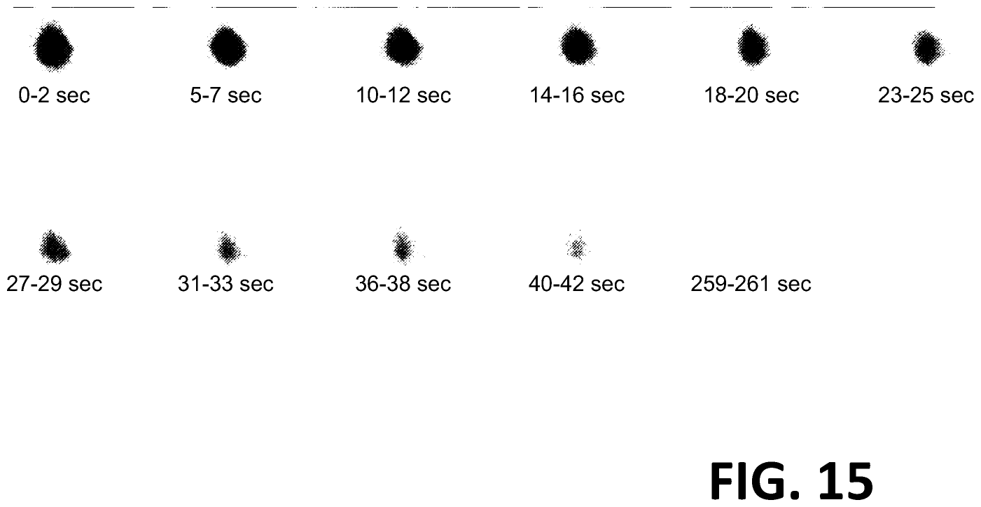

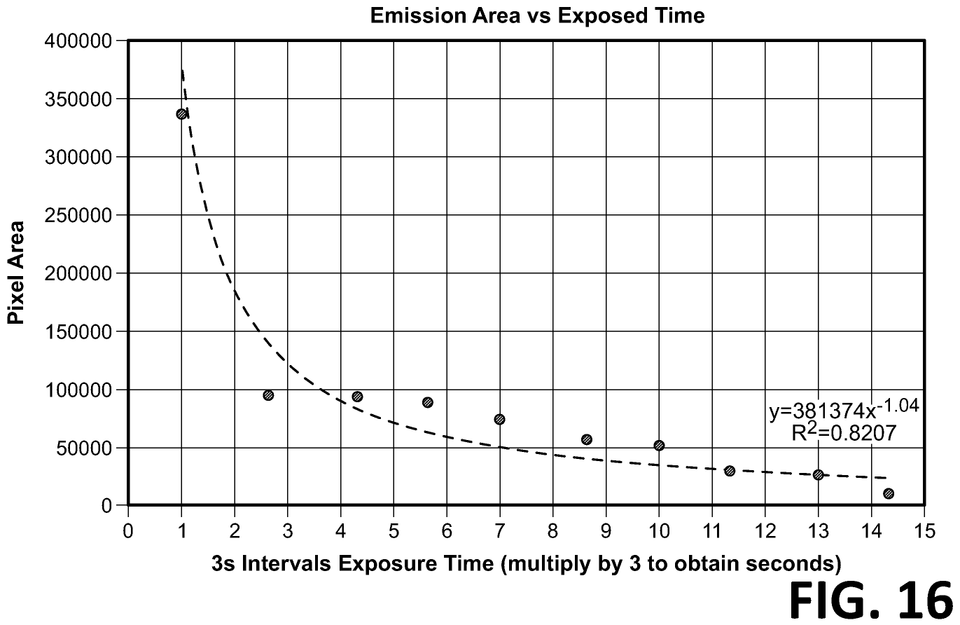

After the raw images were obtained, a color thresholding technique was performed. The color thresholding changes any pixel in the image with a red value of 0-255, a green value of 0-255, and a blue value of 0-12 into white. Any pixel in the image with a red value of 0-255, a green value of 0-255, and a blue value of 12-255 changes to black. This creates an image with only black (0 intensity) and white (255 intensity). After color thresholding, a noise removal algorithm was performed. Given any pixel in the image, the algorithm takes the median value of the surrounding area of 6 pixel radius and compares the given pixel intensity with the median area intensity. If the pixel intensity is a value of 50 or less than the median area intensity value, the pixel is changed to white. This is performed on every pixel in the image parallelly. The same color thresholding and noise removal algorithm was performed on all 11 raw images. The resulting images are illustrated in FIG. 15. Using the known exposure times of the raw images, as well as the known pixel area from the processed images, the relationship between emission area (in pixels) and time (given by exposure number) can be plotted, as illustrated in FIG. 16. Using the plotted relationship, it is possible to determine mathematical relationships between the pixel area and emission time.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device for radiation dosimetry, the device comprising:
a storage phosphor element configured to absorb and store ionizing radiation;
a light source configured to illuminate the storage phosphor element;
a photodetector configured to capture a light emission from the storage phosphor element; and
a computing device comprising a processor and a memory operably coupled to the processor, the memory having computer-executable instructions stored thereon that, when executed by the processor, cause the processor to correlate an intensity of the light emission captured by the photodetector to a radiation dosage.

2. The device of claim 1, wherein the storage phosphor element is a storage phosphor plate.

3. The device of claim 1, wherein the storage phosphor element comprises a photostimulable europium doped BaFBr, CsBr material, or photoexcitable samarium doped BaFCl, BaBPO₅ phosphor or glass material.

4. The device of claim 1, wherein the photodetector comprises an image sensor comprising one or more photodiodes.

5. (canceled)

6. The device of claim 1, further comprising a filter arranged between the storage phosphor element and the photodetector.

7. (canceled)

8. (canceled)

9. (canceled)

10. (canceled)

11. (canceled)

12. (canceled)

13. (canceled)

14. (canceled)

15. The device of claim 1, further comprising a housing, wherein the storage phosphor element and the light source are arranged inside the housing.

16. The device of claim 15, wherein the housing is configured to detachably couple to the device and wherein the housing is configured to maintain the storage phosphor element in a fixed position and/or orientation relative to the light source, and wherein the housing is configured to maintain the storage phosphor element in a fixed position and/or orientation relative to the photodetector.

17. (canceled)

18. (canceled)

19. (canceled)

20. The device of claim 1, wherein the memory has further computer-executable instructions stored thereon that, when executed by the processor, cause the processor to analyze the light emission to determine the intensity of the light emission.

21. The device of claim 1, wherein the memory has further computer-executable instructions stored thereon that, when executed by the processor, cause the processor to generate display data for the radiation dosage and cause the processor to store in the memory the radiation dosage.

22. (canceled)

23. (canceled)

24. The device of claim 1, wherein the device is a portable electronic device.

25. The device of claim 24, wherein the portable electronic device is a smartphone.

26. The device of claim 1, wherein the storage phosphor element is a photostimulable storage phosphor element and wherein the light emission is a photo-stimulated light emission.

27. (canceled)

28. The device of claim 1, wherein the storage phosphor element is a photoexcitable storage phosphor element and wherein the light emission is a photo-excited light emission.

29. (canceled)

30. A method for performing radiation dosimetry with a portable electronic device comprising a storage phosphor element, a light source, and a photodetector, the method comprising:
illuminating, using the light source, the storage phosphor element, wherein the storage phosphor element has been exposed to ionizing radiation;
capturing, using the photodetector, a light emission from the storage phosphor element; and
correlating an intensity of the light emission captured by the photodetector to a radiation dosage.

31. The method of claim 30, further comprising exposing the storage phosphor element to the ionizing radiation.

32. The method of claim 31, wherein the ionizing radiation comprises at least one of alpha particles, beta particles, gamma rays, or x-rays.

33. The method of claim 30, further comprising filtering the light emission, wherein the filtered light emission is captured by the photodetector.

34. The method of claim 30, further comprising calibrating the storage phosphor element.

35. The method of claim 34, wherein the step of calibrating the storage phosphor element comprises: exposing the storage phosphor element to a plurality of predetermined doses of ionizing radiation; illuminating, using the light source, the storage phosphor element after exposure to each respective predetermined dose; capturing, using the photodetector, a respective light emission from the storage phosphor element after exposure to each respective predetermined dose; and determining a relationship between intensity of photo-simulated light emission and radiation dosage.

36. The method of claim 35, wherein the step of calibrating the storage phosphor element comprises illuminating, using the light source, the storage phosphor element for a predetermined period of time.
